(19) United States
(12) Patent Application Publication
(10) Pub. No.: US 2013/0073313 A1
(43) Pub. Date: Mar. 21, 2013

(54) METHOD FOR USING PHYSICIAN SOCIAL NETWORKS BASED ON COMMON PATIENTS TO PREDICT COST AND INTENSITY OF CARE IN HOSPITALS

(71) Applicants: Nicholas A. Christakis, Cambridge, MA (US); Michael L. Barnett, Brookline, MA (US); Bruce E. Landon, Newton, MA (US)

(72) Inventors: Nicholas A. Christakis, Cambridge, MA (US); Michael L. Barnett, Brookline, MA (US); Bruce E. Landon, Newton, MA (US)

(73) Assignee: PRESIDENT AND FELLOWS OF HARVARD COLLEGE, Cambridge, MA (US)

(21) Appl. No.: 13/701,064

(22) PCT Filed: Jul. 8, 2011
(86) PCT No.: PCT/US11/43347

§ 371 Date: Nov. 30, 2012

Related U.S. Application Data
(60) Provisional application No. 61/362,510, filed on Jul. 8, 2010.

(51) Int. Cl. G06Q 50/22

(52) U.S. Cl. 705/2

(57) ABSTRACT

Health care costs can be predicted for a particular hospital relative to other hospitals by examining physician-physician network structural measures within the hospitals. The physician-physician networks are ascertained by examining patient sharing data between physicians and the network structural measures include the median adjusted degree of all physicians in the hospitals, and the relative centrality of primary care physicians in the hospitals. For any particular hospital, the median adjusted degree and the primary care physician relative centrality of can be compared to the median adjusted degree and median primary care physician relative centrality over all the hospitals to determine whether the health care costs for the particular hospital will be higher or lower than the other hospitals.

### GOVERNMENT RIGHTS

This invention was made with government support under Grant No. AG031093 awarded by the National Institute for Health. The government has certain rights in the invention.

### TECHNICAL FIELD

This invention relates to health care and methods of predicting comparative costs of health care between hospitals by examining physician networks.

### BACKGROUND ART

American regions and hospitals in those regions differ markedly in health care spending and resource use. Research has shown that this variation is not fully explained by hospital or patient characteristics, and is not associated with improved patient outcomes or experiences with care. Prior research has also suggested that one contribution to hospital-level variations in care is physician-to-physician interactions and the structure of the networks defined by such interactions. These interactions are important because collectively, such physician interactions contribute to the culture of an institution. For instance, physicians rely on each other as trusted sources of medical advice and information.

Network analysis has had prior successful applications in understanding the behavior of organizations such as academic departments, boards of company directors, and artistic collaborations. Some prior research has used these methods to examine physician advice networks and the diffusion of information among physicians; however, these studies have included relatively small samples of physicians or were limited to studying the adoption of a single technology or drug.

Other larger scale studies have used data from the Medicare program regarding 2.6 million patients cared for by 61,146 physicians associated with 528 hospitals to discern professional networks of physicians by examining patient sharing between physicians.

However, none of these studies have indicated how the physician networks, once ascertained, affect health care costs either at individual hospitals or across entire regions.

### DISCLOSURE OF INVENTION

In accordance with the principles of the invention, comparative health care costs can be predicted by examining physician-physician network structural measures within hospitals.

In one embodiment, the network structural measures include the median adjusted degree for all physicians and the relative centrality of primary care physicians (PCPs).

In another embodiment, the physician-physician networks are ascertained by examining patient sharing data between physicians.

In still another embodiment, the physician-physician networks are ascertained by examining patient sharing data between physicians assigned to the same hospital.

In yet another embodiment, the median adjusted degree and the PCP relative centrality of each hospital are compared to the median adjusted degree and median PCP relative centrality for all hospitals.

### BRIEF DESCRIPTION OF DRAWINGS

FIG. 1 is a flowchart showing the steps in an illustrative process for predicting comparative hospital health care intensity and costs using hospital physician-physician network measures.

FIG. 2 is a table of characteristics of hospitals used in the example calculations.

FIG. 3 is a table of average calculated network measures versus various hospital characteristics as found in the example calculations.

FIGS. 4A and 4B are network graphs of two similarly sized hospitals in the example where the network for the hospital in FIG. 4A is centered on medical specialists and surgeons and the network of the hospital in FIG. 4B is more evenly mixed and primary care centered.

FIG. 5 is a graph representing hospital network characteristics versus total Medicare costs in the example.

FIG. 6 shows adjusted relationships between hospital physician-physician network structure and hospital health care costs, controlling for hospital characteristics.

### BEST MODE FOR CARRYING OUT THE INVENTION

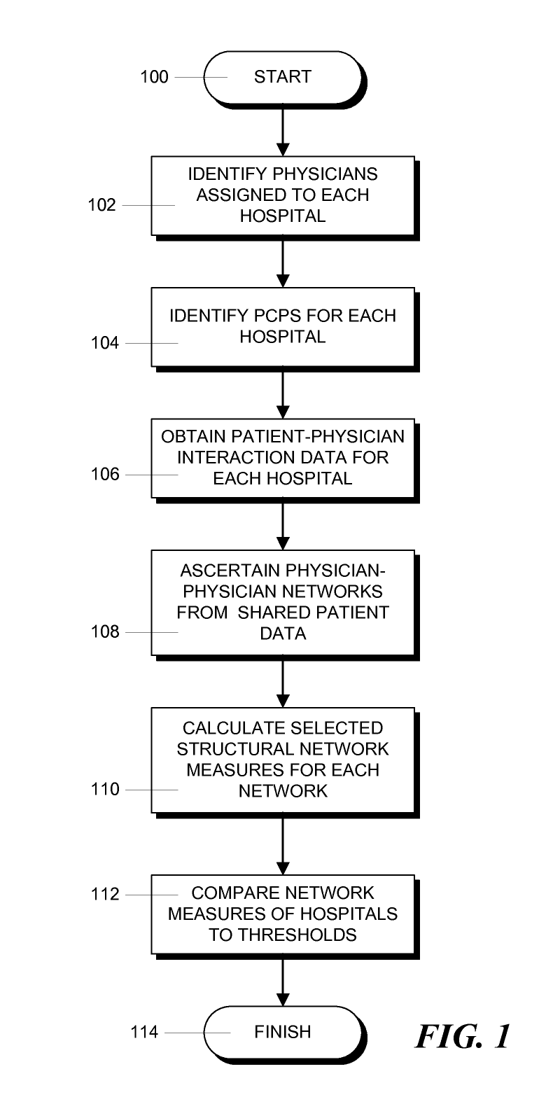

FIG. 1 shows the steps in an illustrative process for comparing predicted health care costs for a particular hospital to other hospitals. The process begins in step 100 and proceeds to step 102 where physicians assigned to the hospitals are identified. This is done by examining the hospital referral region (HRR) of each hospital. First, physicians with offices in the HRR for a hospital are identified. Then, using the method described in an article entitled “Assigning Ambulatory Patients and Their Physicians to Hospitals: a Method for Obtaining Population-based Provider Performance Measurements”, J. P, Bynum, E. Bernal-Delgado and D. Gottlieb, Health Service Research, v. 42, pp 45-62 (2007), physicians with offices located in an HRR are assigned to the associated hospital if they filed most of their inpatient claims at that hospital, or if they did not do any inpatient work, they are assigned to the hospital if most of the patients that they saw received inpatient care at that hospital.

Next, in step 104, the primary care physicians for each of the hospitals are identified. In order to do this, databases of descriptive information for hospitals and physicians which list specialty information for physicians is examined. Such databases include the 2006 American Hospital Association annual survey, the 2006 American Medical Association (AMA) Masterfile and data from the Medicare program. Physicians are considered as primary care physicians (PCPs) if their primary specialty is internal medicine (with no additional subspecialty), family medicine, general practice, preventive medicine, geriatrics or general osteopathy. All other physicians are classified as medical or surgical specialists, or “other” (e.g. psychiatry).

Then, in step 106, information regarding patient-physician interactions is obtained in order to determine which physicians share patients. One source of such data is encounter data that can be obtained from the Medicare Carrier File. Next, in step 108, a physician-physician network for each hospital is ascertained. To define a network of relationships between the physicians, a relationship (tie) is identified between two doctors if they each had a significant encounter with one or more common patients. Such encounters are defined as the presence of a CPT code for a face-to-face office, or hospital, visit or a meaningful procedure code to capture bundled encounters where an evaluation and management service might not be billed.

Once the physician-physician network has been mapped out for each hospital, two network structural measures: degree and betweenness centrality for PCPs are calculated for each network in step 110. Degree is defined as the number of ties a doctors has, or equivalently, the number of doctors a physician is connected to through patient sharing. The doctors contributing to a physicians' degree can be any doctor a physician's patients have seen, including both those assigned to the physician's hospital and those not so assigned. Each physician's degree is adjusted for patient volume by dividing the degree by the total number of patients shared with other doctors. To summarize a hospital network's local connectedness, the median adjusted degree of all physicians at each individual hospital is calculated. On average, hospitals with higher median adjusted degree have physicians whose patients' care is spread over many other doctors. Degree can be calculated using conventional statistical computation software, such as R version 2.10 using the igraph package (version 0.5.3).

The betweenness centrality of a physician is the number of shortest paths between any pair of doctors in a hospital that includes the physician. This is a conventional network measure whose value is calculated by well-known methods. The calculation of centrality is confined to doctors within a hospital network and measures how central a physician is in the network of doctors in her hospital. The relative centrality of PCPs, medical, and surgical specialists can be measured within a hospital network by calculating the ratio of the mean centrality of PCPs or specialists over the mean centrality of all other doctors in a hospital. Some small hospitals where the relative centrality cannot be calculated can be excluded from the relevant analyses.

Finally, in step 112, the physician-physician network structural measures for each of the hospitals are compared to the median values of those measures over all hospitals. It has been found that hospitals with median adjusted degrees higher than the overall median have higher total health care costs than hospitals with median adjusted degrees lower than the overall median. Similarly hospitals with PCP relative centrality lower than the overall median relative centrality have a higher total health care cost than hospitals with PCP relative centrality higher than the overall median relative centrality. Hospitals with both with median adjusted degrees higher than the overall median and PCP relative centrality lower than the overall median relative centrality have the highest health care intensity and total health care costs. The process then ends in step 114.

The following is one example of the inventive method. In this example, data from the Medicare program regarding 2.6 million patients cared for by 65,757 eligible physicians affiliated with 867 general medical surgical hospitals within 50 selected HRRs. After excluding low volume hospitals with an average of 400 or fewer deaths annually and physicians who did not have ties within their assigned hospital, the sample included 61,461 physicians and 528 hospitals. Physician ties were defined using encounter data from the Medicare Carrier File for 2006. Data for 100% of traditional Medicare beneficiaries living in the 50 hospital referral regions (HRR) that were sampled with probability proportional to size was used along with the HRR of Boston. Patients enrolled in Medicare Part A and Part B were included in the analysis, whereas patients enrolled in capitated Medicare Advantage plans were excluded. The 2006 American Hospital Association annual survey and 2006 American Medical Association (AMA) Masterfile were used to obtain descriptive information for hospitals and physicians. For physicians whose specialty information was missing from the AMA Masterfile, the data from the Medicare program was sued.

Measures of cost and care intensity for hospitals were obtained from the Dartmouth Atlas of Health Care, which covered the period from 2001 to 2005. For each hospital, measures of health care spending, number of hospital days, and number of physician visits—all for patients with chronic illness in the last two years of life were examined. All data were adjusted for patient age, sex, race, type of chronic illness, and presence of multiple chronic illnesses. Thus, the measures represent the case-mix-adjusted cost and intensity of care for a population of older patients with comparable life expectancies and levels of illness.

An adjustment was made for factors believed to confound the association of network measures and outcomes, including the number of hospital beds, number of physicians assigned to a hospital, geographic region (Northeast, South, Midwest, West), community size (urban, rural, isolated), teaching hospital status (major, minor, none), ownership (not-for-profit, for-profit, government), and the percentage of admissions from Medicare and Medicaid patients. To adjust for a hospital's technological capacity, an index that weights technologies inversely to their prevalence, giving higher weights to less available technologies was used. For the 20% of hospitals that were missing these data, a dummy variable was used to code for missing values enabling imputation of an overall mean. Lastly, an adjustment was made for the mean patient volume per physician at a hospital, defined for each physician as the number of patients shared in 2006 with other doctors.

The sample of hospitals was then compared to hospitals nationally using χ²or t-tests and tested for differences in network measures across hospital characteristics using one-way analysis of variance tests. Multivariable linear regression was then used to model the effect of each network structure measure on cost or care intensity outcomes, adjusting for hospital characteristics detailed above. Separate models were estimated for each predictor and outcome pairing. Because of a concern that small hospitals might have excessively large or small centrality ratios, outliers below the 5ₜₕ or above the 95ₜₕ percentiles were set to equal the 5ₜₕ and 95ₜₕ percentile values, respectively. To enable regression coefficients to be directly compared, each continuous network predictor and hospital covariate was centered to have mean 0 and standard deviation 1 over the entire sample. Each outcome variable was log transformed.

Regression coefficients were transformed to units of percent change expected in the outcome of interest for the average hospital associated with an increase of one standard deviation in the network measure predictor. All analyses were performed in R version 2.10, using the igraph package (version 0.5.3) for calculating network structure measures and the Im function for multivariable regression models. Hospital networks were visualized using the Fruchterman-Reingold algorithm as implemented in igraph.

A dispersion index was also calculated for each hospital. The dispersion index measures the extent to which a physician's shared patients are spread over a few versus many hospitals. The equation for the dispersion index is as follows:

$${D}_{i} = 1 - {\sum }_{h = 1}^{{N}_{H}} {( \frac{{κ}_{ih}}{{κ}_{i}} )}^{2}$$

where Dᵢ=dispersion index for physician i, h=hospital h, N_{H}=number of hospitals, κᵢ=total strength of physician i, and κₜₕ=strength of physician i in hospital h

The strength of physician i, κᵢ, represents the sum of the weights of all of the ties of physician i. The strength of physician i in hospital h is represented by the expression κᵢₕ. This corresponds to the strength of physician i's ties in hospital h. Therefore, the dispersion index of physician i, Dᵢ, is equal to 0 if a physician shares all of his patients in one hospital, since then κᵢₕ/κᵢ equals 1 and 1−1=0. Conversely, as physician i has ties spread across many different hospitals, the expression (κᵢₕ/κᵢ)² summed across many hospitals will be close to 0 and 1−0=1, so Dᵢ will approach 1. To summarize a hospital's dispersion, the median dispersion index of doctors assigned to that hospital is used.

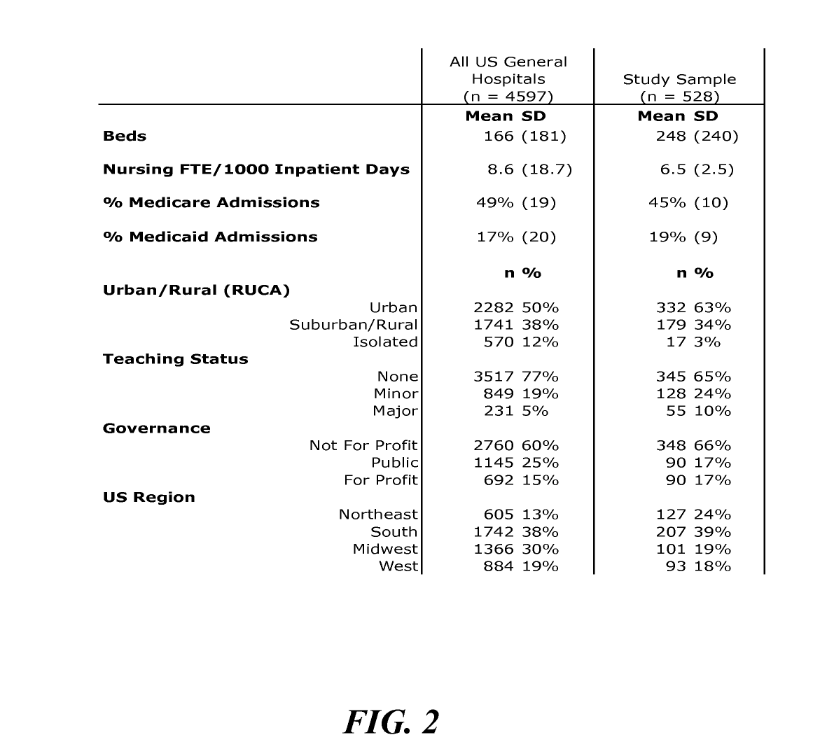

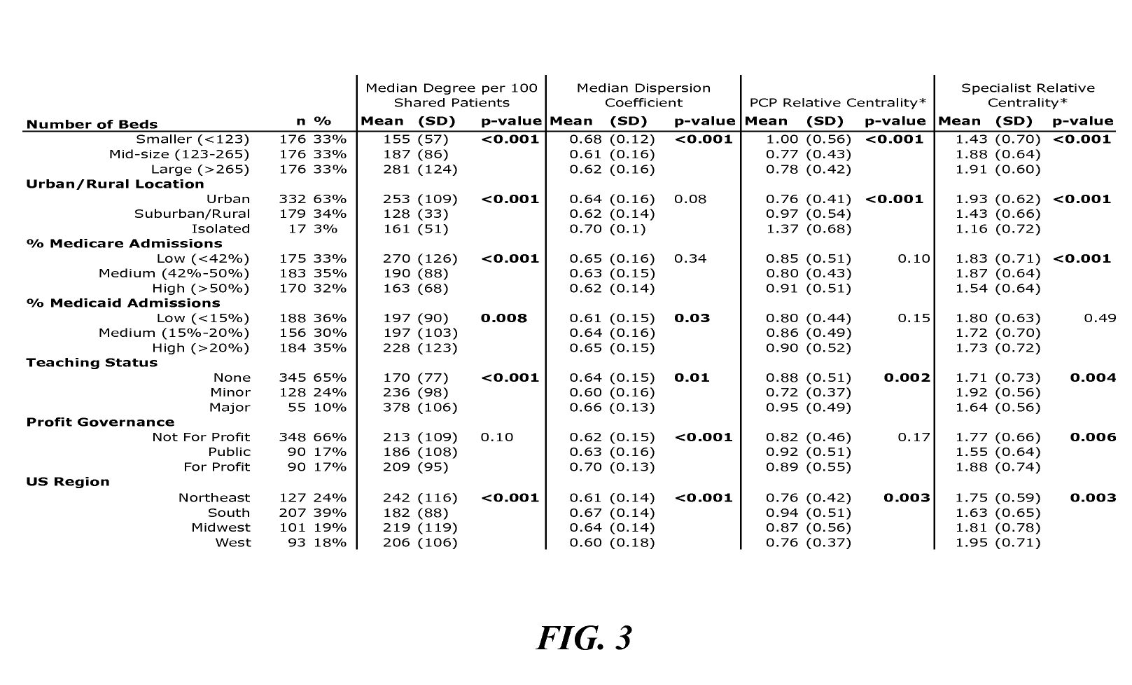

Compared with all general medical/surgical hospitals in the US, the sample contained larger hospitals that were more likely to be in urban settings (p<0.001 for both) as shown in FIG. 2. The average median adjusted degree of a mid-sized hospital in the sample was 187 (SD 86) and ranged from 155 (SD 57) for smaller hospitals to 281 (SD 124) for larger hospitals (p<0.001) as indicated in FIG. 3. Therefore, the typical physician in a mid-sized hospital shared patients with 187 other doctors for every 100 patients shared with other doctors. Overall, median adjusted degree was higher for larger hospitals, hospitals in urban areas, and teaching hospitals (all p<0.001). The average median dispersion index showed less variation, but was also strongly associated with size of hospital. Smaller hospitals had a higher median dispersion index 0.68 (SD 0.12) than mid-sized 0.61 (SD 0.16) or larger hospitals 0.62 (SD 0.16) (p<0.001 for group). This implies that even though physicians in smaller hospitals have lower adjusted degree than larger hospitals (meaning that patients of physicians in smaller hospitals saw fewer different doctors), those physicians were affiliated with more hospitals, on average.

PCP relative centrality decreased with hospital size, from a mean of 1.00 (SD 0.56) in smaller hospitals to 0.78 (SD 0.42) in larger hospitals (p<0.001) whereas specialist relative centrality increased from 1.43 (SD 0.70) for smaller hospitals to 1.91 (SD 0.60) for larger hospitals (p<0.001).

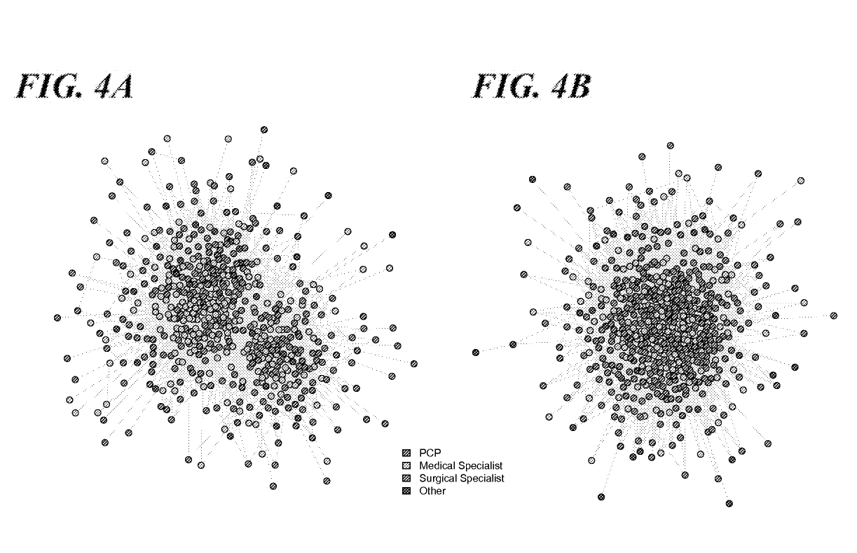

The network graphs of two similarly sized hospitals are depicted in FIGS. 4A and 4B. Each point in each figure represents a physician, colored by the specialty of that physician (red=primary care, orange=medical specialist, green=surgical specialist, blue=other specialist). Each tie between two physicians represents the sharing of 5 or more patients. The network for the hospital in FIG. 4A is centered on medical specialists and surgeons, with PCPs more likely to be in the periphery of the network. In contrast, the network of the hospital in FIG. 4B is more evenly mixed and primary care centered. The relative centrality of PCPs in hospital A is 0.31, 58% lower than in hospital B (PCP relative centrality=0.53).

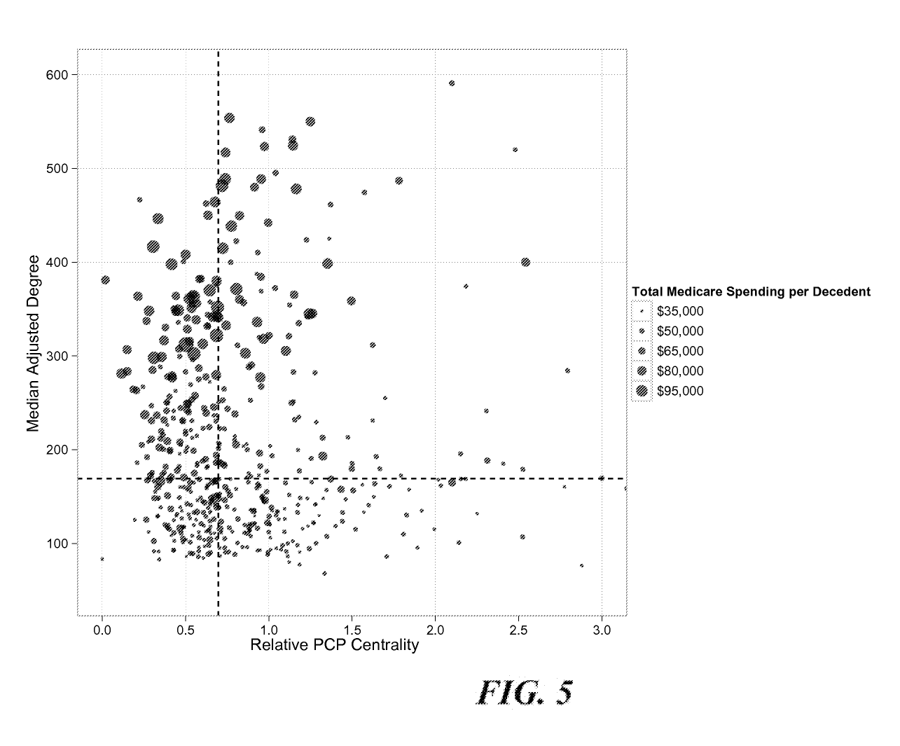

The relationships between median adjusted degree, PCP centrality, and total Medicare spending per hospital are depicted in FIG. 5. In this figure, each point represents a hospital. The size of each point corresponds to the total Medicare spending of the hospital represented by that point. The horizontal axis of the figure corresponds to the relative primary care provider (PCP) centrality in that hospital, and the vertical axis corresponds to the median adjusted degree of physicians in that hospital. Dashed lines 500 and 502 are drawn at the median values of relative PCP centrality and median adjusted degree to guide the eye. In this figure, 18 hospitals (of 521 total with non-missing values) with high PCP centralities>3.2 fall outside the range of the plot.

The hospitals in the top left quadrant have the highest median adjusted degree and lowest PCP relative centrality, meaning that physicians at these hospitals tend to have patients who see a larger network of doctors in addition to having less PCP-centered patient sharing than the rest of the sample. These hospitals have higher total Medicare spending, particularly compared with hospitals in the bottom-right quadrant, which have lower median adjusted degree and higher PCP relative centrality.

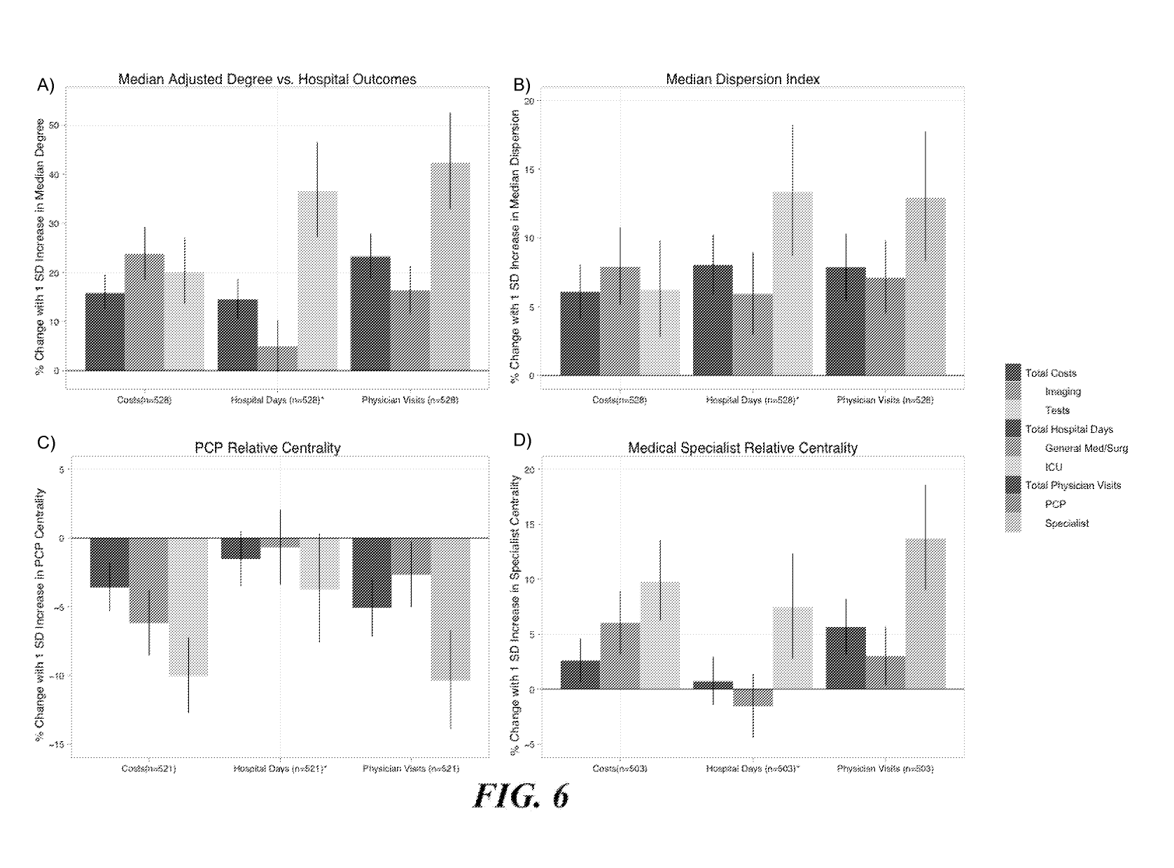

Adjusted relationships between hospital network structure and hospital outcomes, controlling for hospital characteristics, are presented in FIG. 6. For the average hospital in the sample, an increase of one standard deviation (SD) in the median adjusted degree (corresponding roughly to an addition of 107 doctors per 100 patients shared to the typical doctor's number of contacts) was associated with a 15.8% (95% Cl, 12.3 to 19.5) increase in total Medicare spending, 14.5% (95% Cl, 10.5 to 18.7) more hospital days and 23.3% (95% Cl, 18.7 to 27.9) more physician visits in the last 2 years of life.

Similarly, a one SD increase in median dispersion index was associated with a 6.0% (95% Cl, 4.1 to 8.1) increase in total costs, and an 8.0% (95% Cl, 5.8 to 10.3) and 7.9% (95% Cl, 5.4 to 10.3) increase in total hospital days and physician visits, respectively. For increases in both median adjusted degree and median dispersion index, the size of association with hospitalizations and physician visits was much larger for ICU days and medical specialist visits per patient.

Higher centrality of primary care providers within a hospital network was correlated with a decrease in overall spending of 3.6% (95% Cl, −5.3 to −1.8), along with 6.2% (95% Cl, −8.5 to −3.8) lower spending on imaging and 10.0% (95% Cl, −12.7 to −7.2) lower spending on tests for a 1 SD increase. In addition, higher PCP centrality was accompanied by 10.4% (95% Cl, −13.9 to −6.7) fewer medical specialist visits. Conversely, higher specialist centrality was associated with comparable increases in spending. No significant effect was found for the association between surgeon relative centrality and hospital spending or utilization outcomes (data not shown).

The results show that the structure of physician patient-sharing networks is significantly associated with Medicare spending and care patterns at the hospital level. Higher adjusted degree, dispersion index, and relative specialist centrality are associated with higher spending and health care utilization even after adjusting for hospital characteristics such as size. In contrast, higher PCP relative centrality is associated with lower spending and utilization. These results are consistent with the hypothesis that network measures reflective of poorer coordination of care within hospitals are associated with higher costs and care intensity.

Using the measures of adjusted degree and dispersion index, hospitals with physicians whose patients see a broader array of other doctors spread over a larger number of other medical centers have higher levels of spending. They also use more hospital care, physician visits, tests and imaging, which could reflect redundancy due to lack of familiarity with their patients or a tendency towards more aggressive referral and intervention. In contrast to this result, a network measure that likely reflects greater coordination of care, PCP relative centrality, was associated with lower imaging and test spending in addition to fewer ICU days and specialist visits.

This example is subject to several limitations. First, network structure was ascertained based on the presence of shared patients using administrative data. These methods do not indicate what information or behaviors, if any, pass across the ties defined by shared patients. Second, the data are cross-sectional. The local network of physicians and patients in a hospital or region is likely to be in flux, and future analyses could be enhanced by using longitudinal data. Third, there was no explicit control for the strength of physician-physician or patient-physician connections in the analyses. Lastly, Medicare spending and care intensity was sued to describe the performance of hospitals, measures that may not reflect spending in other patient populations.

While the invention has been shown and described with reference to a number of embodiments thereof, it will be recognized by those skilled in the art that various changes in form and detail may be made herein without departing from the spirit and scope of the invention as defined by the appended claims.

What is claimed is:

1. A method for predicting health care costs and intensity of care in a plurality of hospitals comprising:
(a) identify physicians assigned to each of the plurality of hospitals;
(b) identify primary care physicians of the physicians assigned to each hospital;
(c) ascertain physician-physician networks for each hospital;
(d) calculate selected structural network measures for each network; and
(d) compare calculated network measures to thresholds.

2. The method of claim 1 wherein step (d) comprises calculating the median adjusted degree of each hospital and the primary care physician (PCP) relative centrality for each hospital.

3. The method of claim 2 wherein the median adjusted degree of each hospital is calculated by calculating the adjusted degree for each physician assigned to that hospital and calculating the median adjusted degree of all physicians assigned to that hospital.

4. The method of claim 3 wherein the adjusted degree for each physician is calculated by calculating the degree of each physician and dividing the degree by the total number of patients shared with other doctors.

5. The method of claim 2 wherein primary care physician (PCP) relative centrality for each hospital is calculated by calculating the ratio of the mean centrality of PCPs assigned to a hospital to the mean centrality of all other doctors assigned to that hospital.

6. The method of claim 1 wherein in step (c) physician-physician networks are ascertained by examining patient sharing data between physicians.

7. The method of claim 6 wherein, in step (c), physician-physician networks are ascertained by examining patient sharing data between physicians assigned to the same hospital.

8. The method of claim 1 wherein in step (d) the relative centrality of PCPs in a hospital is compared to the median relative centrality of PCPs over all of the plurality of hospitals.

9. The method of claim 1 wherein in step (d) the relative centrality of PCPs in a hospital is compared to the median relative centrality of PCPs over all of the plurality of hospitals.

10. The method of claim 1 wherein step (a) comprises identifying the hospital referral region associated with each hospital, and assigning physicians with offices located in a hospital referral region to the associated hospital when the physicians did inpatient work and filed most of their inpatient claims at that hospital, and when the physicians did not do any inpatient work, if most of the patients that the physicians saw received inpatient care at that hospital.
